(19) United States
(12) Patent Application Publication
(10) Pub. No.: US 2011/0072186 A1
(43) Pub. Date: Mar. 24, 2011

(54) PORTABLE COMPUTER CAPABLE OF CONVERTING INTERNAL STORAGE DEVICE INTO EXTERNAL STORAGE DEVICE

(76) Inventor: Chun-Pin CHENG, Jung Ho (TW)

(21) Appl. No.: 12/650,839

(22) Filed: Dec. 31, 2009

(30) Foreign Application Priority Data
Sep. 23, 2009 (TW) 098132032

(51) Int. Cl. G06F 13/00; G06F 12/00; G06F 12/02

(52) U.S. Cl. 710/315; 710/316; 710/300; 711/103; 711/112; 711/E12.001; 711/E12.008

(57) ABSTRACT

A portable computer capable of converting an internal storage device into an external storage device and, without being booted up, functioning as the external storage device is disclosed. The portable computer includes: an external interface connector; a switcher connected to an internal storage device, a south bridge chip, and an interface converter, and is configured to switch between the south bridge chip and the interface converter and thus allow one of the south bridge chip and the interface converter to be electrically conducted to the internal storage device; the interface converter connected to the switcher and an external interface controller to allow an interface of the external interface controller to be changed and thus be fit for use with the internal storage device; and the external interface controller connected to an interface switcher and the external interface connector and configured to process signals from the external interface connector.

### FIELD OF THE INVENTION

The present invention relates to portable computers, and more particularly, to a portable computer capable of converting an internal storage device into an external storage device.

### BACKGROUND OF THE INVENTION

U.S. Pat. No. 7,459,629B2, entitled “Extension box of storage media”, discloses an extension box for accommodating storage media therein such that, for example, the storage media function as a portable hard disk drive. According to U.S. Pat. No. 7,459,629B2, the extension box disclosed therein improves on the prior art in that the extension box of U.S. Pat. No. 7,459,629B2 features enhanced heat dissipation.

A notebook computer is always provided therein with a high-capacity storage device, such as a hard disk drive (HDD) or a solid-state hard disk drive (SSD). To enable another computer to access data on the high-capacity storage device of the notebook computer, the notebook computer has to run in a window environment while the user is using Ethernet, USB communication, FTP protocol, and an online hard disk drive.

Having noted that a high-capacity storage device provided inside a conventional portable computer is less efficient than a portable hard disk drive in reading and writing data, the inventor of the present invention endeavors to improve the prior art and eventually devises a portable computer for turning an internal storage device into an external storage device.

### SUMMARY OF THE INVENTION

The objective of the present invention is to provide a portable computer capable of functioning as the external storage device without being booted up and thereby making good use of a storage device (such as a SATA hard disk drive) inside the portable computer.

To achieve the above and other objectives, the present invention provides a portable computer capable of converting an internal storage device into an external storage device, comprising: an external interface connector; a switcher with an end connected to an internal storage device and another end connected to a south bridge chip and an interface converter so as for the switcher to switch between the south bridge chip and the interface converter and thereby allow one of the south bridge chip and the interface converter to be electrically conducted to the internal storage device; the interface converter with an end connected to the switcher and another end connected to an external interface controller to thereby allow an interface of the external interface controller to be changed and thus be fit for use with the internal storage device; and the external interface controller with an end connected to the interface switcher and another end connected to the external interface connector to thereby at least process signals from the external interface connector.

Furthermore, to achieve the above and other objectives, the present invention provides a portable computer capable of converting an internal storage device into an external storage device, comprising: an external interface connector; a switcher with an end connected to an internal storage device and another end connected to a south bridge chip and an external interface controller so as for the switcher to switch between the south bridge chip and the external interface controller and thereby allow one of the south bridge chip and the external interface controller to be electrically conducted to the internal storage device; and the external interface controller with an end connected to the switcher and another end connected to the external interface connector to thereby at least process signals from the external interface connector.

### BRIEF DESCRIPTION OF THE DRAWINGS

To enable persons skilled in the art to gain insight into the structures, features, and effects of application of the present invention, the present invention is illustrated with preferred embodiments in conjunction with the accompanying drawings, wherein:

FIG. 1 is a schematic view of the framework of a first embodiment according to the present invention;

FIG. 2 is a block diagram of specific implementation of the framework of the first embodiment according to the present invention;

FIG. 3 is a schematic view of the framework of a second embodiment according to the present invention; and

FIG. 4 is a block diagram of specific implementation of the framework of the second embodiment according to the present invention.

### DETAILED DESCRIPTION OF THE INVENTION

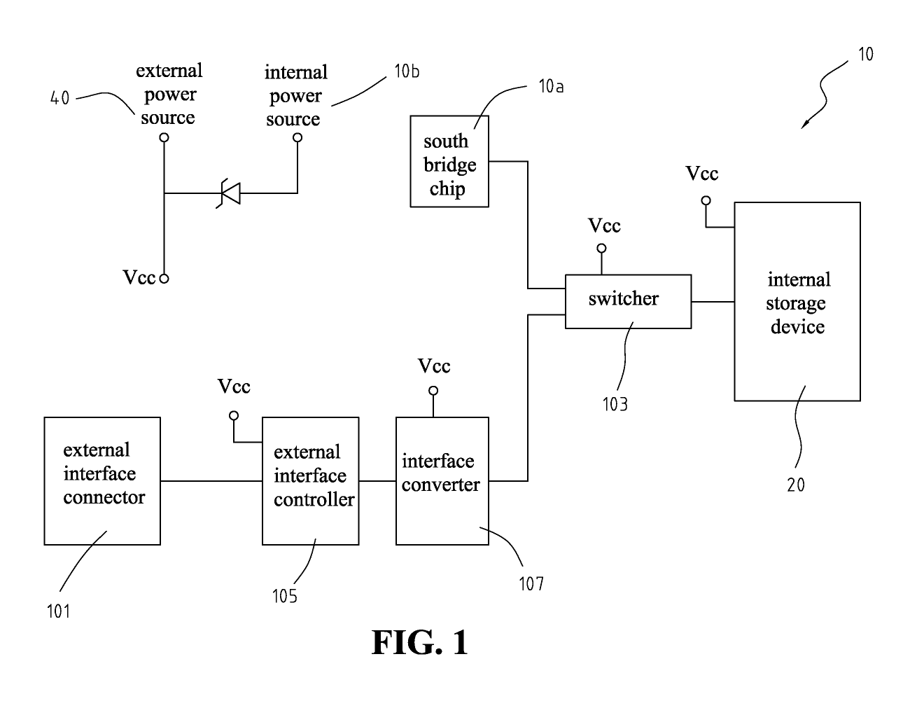

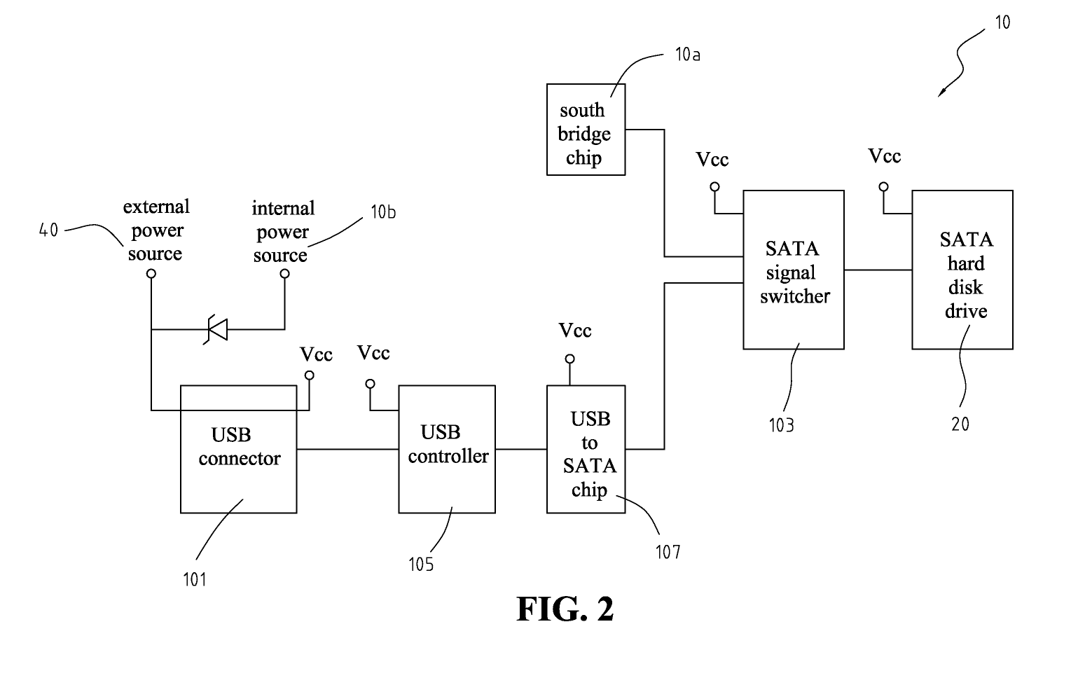

Referring to FIG. 1, there is shown a schematic view of the framework of a first embodiment according to the present invention. Referring to FIG. 2, there is shown a block diagram of specific implementation of the framework of the first embodiment according to the present invention. The present invention provides a portable computer 10. Where hardware components of the portable computer 10 are directly related to the present invention, the hardware components are shown in the drawings. The drawings omit a component of the portable computer 10 when the component is not directly related to the present invention. The portable computer 10 of the present invention is capable of converting an internal storage device into an external storage device. In practice, an internal storage device 20 (such as a SATA hard disk drive or a SATA solid-state hard disk drive) inside the portable computer 10 is converted into an external storage device, such that the portable computer 10 functions as an external SATA hard disk drive. According to the present invention, the portable computer 10 comprises an external interface connector 101, a switcher 103, an interface converter 107, and an external interface controller 105 as described below.

The external interface connector 101 is electrically connected to another electronic device (such as a desktop computer). In practice, the external interface connector 101 is a USB connector, for example. A user may use a USB cable (not shown) to link up another electronic device and the portable computer 10.

The switcher 103 has one end connected to the internal storage device 20 and the other end connected to a south bridge chip 10a and the interface converter 107. The switcher 103 switches between signals of the south bridge chip 10a and signals of the interface converter 107 to allow one of the south bridge chip 10a and the interface converter 107 to be electrically conducted to the internal storage device 20. In practice, the switcher 103 is a related conventional circuit. In general, after the portable computer 10 starts to function as an external storage device, the south bridge chip 10a does not generate any signals; meanwhile, the switcher 103 allows the interface converter 107 to be electrically conducted to the internal storage device 20 as soon as the switcher 103 detects a signal from the interface converter 107. After the portable computer 10 boots and executes a window operating system, the interface converter 107 does not generate any signals; meanwhile, the switcher 103 allows the south bridge chip 10a to be electrically conducted to the internal storage device 20 as soon as the switcher 103 detects a signal from the south bridge chip 10a.

The interface converter 107 has one end connected to the switcher 103 and the other end connected to the external interface controller 105. The interface converter 107 allows an interface of the external interface controller 105 to be changed and thus be fit for use with the internal storage device 20. In practice, the interface converter 107 is a conventional USB to SATA chip.

The external interface controller 105 has one end connected to the interface switcher 107 and the other end connected to the external interface connector 101. The external interface controller 105 at least processes signals from the external interface connector 101. In practice, the external interface controller 105 is a conventional USB controller comprising a USB engine, for example.

The switcher 103, the interface converter 107, and the external interface controller 105 are integrated in a single chip.

An external power source 40 (such as an AC/DC adaptor) or an internal power source 10b (such as a rechargeable lithium-ion battery) of the portable computer 10 supplies power to the internal storage device 20, the switcher 103, the interface converter 107, and the external interface controller 105. Take a USB external interface connector as an example, where the external power source 40 is in use, the external power source 40 supplies power via a power terminal of the USB external interface connector 101.

In the first embodiment of the present invention, a USB interface and a SATA interface are disclosed. However, persons skilled in the art and well informed of the technical spirit embodied in the first embodiment of the present invention can readily turn a SATA interface into another interface (such as IDE interface) and select a conventional USB to IDE chip to be a means of specific implementation of the interface converter 107. The changes should fall within the equivalent scope of the present invention.

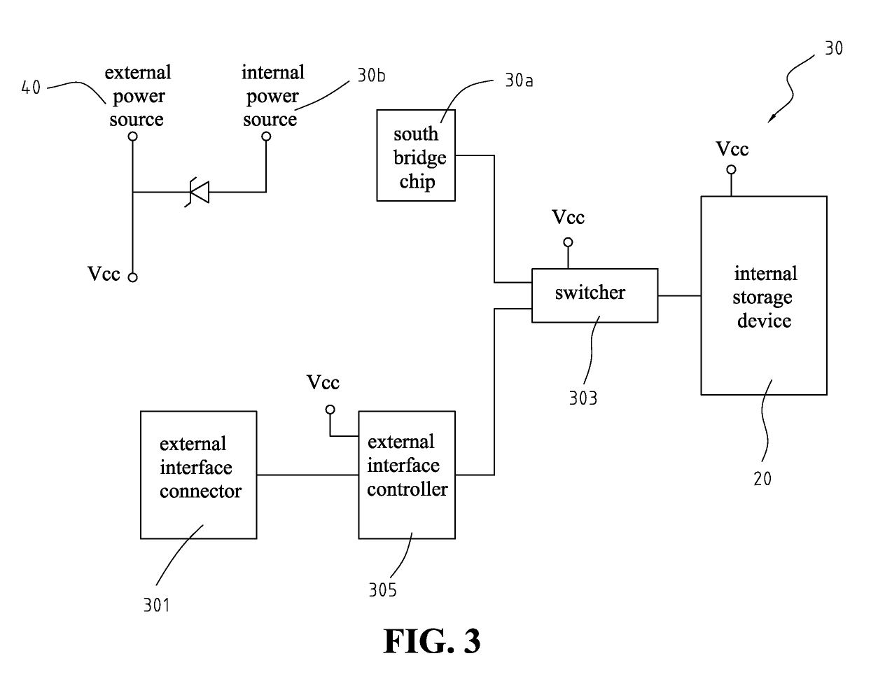

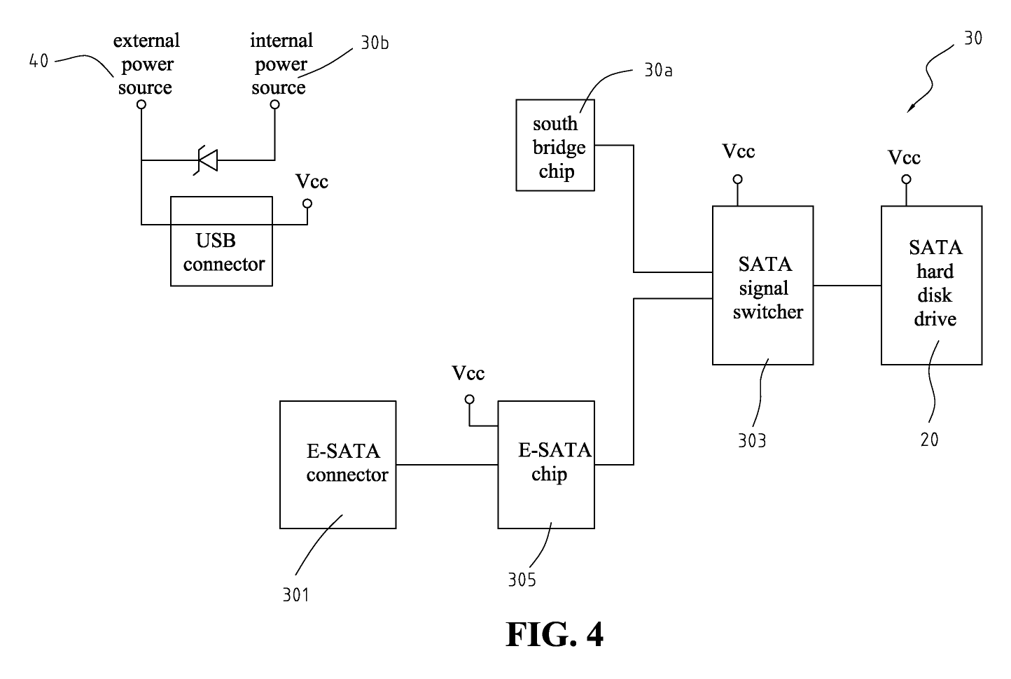

Referring to FIG. 3, there is shown a schematic view of the framework of a second embodiment according to the present invention. Referring to FIG. 4, there is shown a block diagram of specific implementation of the framework of the second embodiment according to the present invention. The present invention provides a portable computer 30. Where hardware components of the portable computer 30 are directly related to the present invention, the hardware components are shown in the drawings. The drawings omit a component of the portable computer 30 when the component is not directly related to the present invention.

Where an interface (such as SATA) for use with an internal storage device 20 of the portable computer 30 can directly function as an external interface (such as E-SATA), the second embodiment of the present invention is applicable to the internal storage device 20. According to the present invention, the portable computer 30 comprises an external interface connector 301, a switcher 303, and an external interface controller 305 as described below.

The external interface connector 301 is electrically connected to another electronic device (such as a desktop computer). In practice, the external interface connector 301 is an E-SATA connector for example. A user may use an E-SATA cable (not shown) to link up another electronic device and the portable computer 30.

The switcher 303 has one end connected to the internal storage device 20 and the other end connected to a south bridge chip 30a and the external interface controller 305. The switcher 303 switches between signals of the south bridge chip 30a and signals of the external interface controller 305 to allow one of the signal of the south bridge chip 30a and the signal of the external interface controller 305 to be electrically conducted to the internal storage device 20. In practice, the switcher 303 is a related conventional circuit. In general, after the portable computer 30 starts to function as an external storage device, the south bridge chip 30a does not generate any signals; meanwhile, the switcher 303 allows the external interface controller 305 to be electrically conducted to the internal storage device 20 as soon as the switcher 103 detects signals of the external interface controller 305. After the portable computer 30 boots and executes a window operating system, the external interface controller 305 does not generate any signals; meanwhile, the switcher 303 allows the south bridge chip 30a to be electrically conducted to the internal storage device 20 as soon as the switcher 303 detects signals from the south bridge chip 30a.

The external interface controller 305 has one end connected to the switcher 303 and the other end connected to the external interface connector 301. The external interface controller 305 at least processes signals from the external interface connector 101. In practice, the external interface controller 305 is a conventional E-SATA controller, for example.

The switcher 303 and the external interface controller 305 are integrated in a single chip.

The external power source 40 (such as an AC/DC adaptor) or an internal power source 30b (such as a rechargeable lithium-ion battery) of the portable computer 30 supplies power to the internal storage device 20, the switcher 303, and the external interface controller 305. The portable computer 30 is always equipped with a USB connector for connection with an external USB electronic device (such as a USB flash drive). Where the external power source 40 is in use, the external power source 40 supplies power via a power terminal of the USB connector, and the power terminal of the USB connector is electrically connected to the internal storage device 20, the switcher 303, and the external interface controller 305.

The portable computers 10, 30 are each a notebook computer, for example.

The present invention provides a portable computer capable of functioning as an external storage device without being booted up and thereby increasing the value-add of the portable computer. The above technical features embody the advantages of the present invention.

The foregoing embodiments are provided to illustrate the present invention and are not intended to be restrictive of the scope of implementation of the present invention. It should be understood by those in the art that obvious variations and modifications can be made to the foregoing embodiments without departing from the substantive disclosure of the present invention.

What is claimed is:

1. A portable computer capable of converting an internal storage device into an
external storage device, comprising:
an external interface connector;
a switcher with an end connected to an internal storage device and another end connected to a south bridge chip and an interface converter so as for the switcher to switch between the south bridge chip and the interface converter and thereby allow one of the south bridge chip and the interface converter to be electrically conducted to the internal storage device;
the interface converter with an end connected to the switcher and another end connected to an external interface controller to thereby allow an interface of the external interface controller to be changed and thus be fit for use with the internal storage device; and
the external interface controller with an end connected to the interface switcher and another end connected to the external interface connector to thereby at least process signals from the external interface connector.

2. The portable computer of claim 1, wherein the switcher is a SATA switcher, and the internal storage device is one of a SATA hard disk drive and a SATA solid-state hard disk drive.

3. The portable computer of claim 2, wherein the external interface connector is a USB connector.

4. The portable computer of claim 3, wherein the interface converter is a USB to SATA converter.

5. The portable computer of claim 3, wherein the external interface controller is a USB controller.

6. The portable computer of claim 1, wherein the switcher, the interface converter, and the external interface controller are integrated in a single chip.

7. The portable computer of claim 1, wherein an external power source or an internal power source of the portable computer supplies power to the internal storage device, the switcher, the interface converter, and the external interface controller.

8. The portable computer of claim 1, wherein the portable computer is a notebook computer.

9. A portable computer capable of converting an internal storage device into an
external storage device, comprising:
an external interface connector;
a switcher with an end connected to an internal storage device and another end connected to a south bridge chip and an external interface controller so as for the switcher to switch between the south bridge chip and the external interface controller and thereby allow one of the south bridge chip and the external interface controller to be electrically conducted to the internal storage device; and
the external interface controller with an end connected to the switcher and another end connected to the external interface connector to thereby at least process signals from the external interface connector.

10. The portable computer of claim 9, wherein the switcher is a SATA switcher, and the internal storage device is one of a SATA hard disk drive and a SATA solid-state hard disk drive.

11. The portable computer of claim 10, wherein the external interface connector is an E-SATA connector.

12. The portable computer of claim 11, wherein the external interface controller is an E-SATA controller.

13. The portable computer of claim 9, wherein the switcher and the external interface controller are integrated in a single chip.

14. The portable computer of claim 9, wherein an external power source or an internal power source of the portable computer supplies power to the internal storage device, the switcher, the interface converter, and the external interface controller.

15. The portable computer of claim 9, wherein the portable computer is a notebook computer.
